(19) United States
(12) Patent Application Publication
(10) Pub. No.: US 2015/0291177 A1
(43) Pub. Date: Oct. 15, 2015

(54) SPEED BUMP DETECTION APPARATUS AND NAVIGATION DATA UPDATING APPARATUS AND METHOD USING THE SAME

(71) Applicant: Hyundai Motor Company, Seoul (KR)

(72) Inventor: Soo Hyuk LEE, Seoul (KR)

(73) Assignee: Hyundai Motor Company, Seoul (KR)

(21) Appl. No.: 14/564,357

(22) Filed: Dec. 9, 2014

(30) Foreign Application Priority Data
Apr. 14, 2014 (KR) 10-2014-0044113

(51) Int. Cl. B60W 40/10; B60W 30/02; G01C 21/26; B60W 40/105

(52) U.S. Cl. CPC B60W 40/10; B60W 40/105; B60W 30/02; G01C 21/26

(57) ABSTRACT

A speed bump detection apparatus may include a sensor for measuring driving data of a vehicle during forward driving of the vehicle, and a controller for monitoring generation of external disturbances of front wheels and rear wheels and determining presence of a speed bump, in which the controller determines that the speed bump is present when |L−S|≦K, when an external disturbance is generated in a rear wheel, where L is a wheel base of the vehicle, S is a movement distance of the vehicle after an external disturbance is generated in a front wheel, and K is a preset threshold value.

### CROSS-REFERENCE TO RELATED APPLICATION

The present application claims priority to Korean Patent Application No. 10-2014-0044113 filed Apr. 14, 2014, the entire contents of which is incorporated herein for all purposes by this reference.

### BACKGROUND OF THE INVENTION

1. Field of the Invention

The present invention relates to a speed bump detection apparatus, and a navigation data updating apparatus and a navigation data updating method using the same. More particularly, it relates to a technology for recognizing an environment of a road through an Electronic Stability Control (ESC) device to update navigation data in real time and accordingly improving a driving environment of a vehicle based on the updated navigation data.

2. Description of Related Art

When a vehicle is driven, an environment of a road can be recognized by using data collected in the vehicle. An ESC device may be used as a control unit of a vehicle, and the ESC device can recognize an environment of a road through data on speeds of wheels of the vehicle, a speed of the vehicle, and location information, which are collected by the vehicle.

In addition, a navigation system is used, setting of a damping force of a suspension may be changed when a vehicle passes over a speed bump using preset map information.

Accordingly, stresses applied to the vehicle or uncomfortable feelings due to driving of the vehicle may be solved.

However, when a new speed bump is formed or an existing speed bump is eliminated differently from preset map information, a navigation system cannot be updated in real time while not reflecting the reality of a road, and accordingly, it is difficult to control a suspension at a necessary time point.

Thus, map information set in the navigation system in advance cannot reflect an environment of a road in real time. That is, only the suspension can be controlled through preset map data by a navigation system that fails to flexibly cope with an environment change due to reconstruction of a speed bump.

When a vehicle passes over a speed bump, uncomfortable feelings and damage to a suspension and a vehicle body may be caused by a change in the load of a road.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a comfortable feeling to a driver and solve a damage problem of a suspension and a vehicle body of a vehicle by optimally controlling characteristics of the suspension using location information of a speed bump when a vehicle to which an electronic control suspension for controlling a damping force and spring characteristics of the suspension is mounted passes over the speed bump.

However, in a navigation system in which only a suspension can be controlled through preset map data, a predetermined control cannot be performed at a time point when it is necessary to control the suspension or may be performed at an unnecessary time point.

In addition, costs and time loss may be generated to renew road information by separately updating navigation data.

According to various aspects of the present invention, a speed bump detection apparatus may include a sensor for measuring driving data of a vehicle during forward driving of the vehicle, and a controller for monitoring generation of external disturbances of front wheels and rear wheels and determining presence of a speed bump, in which the controller determines that the speed bump is present if |L−S|≦K when an external disturbance is generated in a rear wheel, where L is a wheel base of the vehicle, S is a movement distance of the vehicle after an external disturbance is generated in a front wheel, and K is a preset threshold value.

The controller may continuously monitor |L−S|, and detect the speed bump when a condition of |L−S|≦K is satisfied when an external disturbance is generated in the rear wheel.

The driving data may include speeds of wheels, a speed of the vehicle, and a height of the vehicle.

The sensor may include a wheel speed sensor, a vehicle height sensor, and a vehicle speed sensor.

The sensor may include at least one sensor in each of the front wheels and the rear wheels of the vehicle.

The sensor may include a wheel speed sensor, and the controller may determine an external disturbance when a change rate in a rotating speed of a wheel is a preset value or higher.

The sensor may include a vehicle height sensor, and the controller may determine an external disturbance when a change rate in a height of the vehicle is a preset value or higher.

The controller may be an Electronic Stability Control (ESC) device.

Location information of the speed bump may be measured by at least one of a front wheel camera of the vehicle, a GPS, a radar, an antenna, a highway pass device, an RF terminal, and a front camera and a guide line detection sensor of the vehicle.

According to various aspects of the present invention, a navigation data updating apparatus may include a sensor for measuring driving data of a vehicle during forward driving of the vehicle, and a controller for monitoring generation of external disturbances of front wheels and rear wheels of the vehicle, determining presence of a speed bump, calculating a location of the speed bump, and transmitting an update instruction based on the location of the speed bump, and a navigation unit for receiving the update instruction and updating navigation data in real time, in which the controller determines that a speed bump is present when |L−S|≦K when an external disturbance is generated in a rear wheel, where L is a wheel base of the vehicle, S is a movement distance of the vehicle after an external disturbance is generated in a front wheel, and K is a preset threshold value.

The navigation unit may update the navigation data when the speed bump location information detected by the controller and map information on the navigation system are different.

The location information of the speed bump may be measured by at least one of a front wheel camera of the vehicle, a GPS, a radar, an antenna, a highway pass device, an RF terminal, and a front camera and a guide line detection sensor of the vehicle.

According to various aspects of the present invention, a navigation data updating method may include measuring driving data of a vehicle during driving of the vehicle, through a sensor monitoring generation of external disturbances of front wheels and rear wheels of the vehicle, determining presence of a speed bump, calculating a location of the speed bump, and transmitting an update instruction based on the location of the speed bump, and receiving the update instruction and updating navigation data in real time, in which the controller determines that the speed bump is present when |L−S|≦K when an external disturbance is generated in a rear wheel, where L is a wheel base of the vehicle, S is a movement distance of the vehicle after an external disturbance is generated in a front wheel, and K is a preset threshold value.

The navigation data may be updated when map information on the speed bump on the navigation system and detected location information detected of the speed bump are different.

The controller may monitor generation of an external disturbance through the sensor, detect an external disturbance and store location information, and detect a speed bump in real time while the vehicle is driven through calculation of an interval between external disturbances of the front and rear wheels. The controller may transmit an instruction of updating location information of the speed bump to the navigation unit. The update instruction may include information on a location of the speed bump.

The present invention controls a damping force when a speed bump is present on a travel path of a vehicle, by detecting the speed bump and updating navigation data in real time, and can detect a speed bump newly constructed on a road during driving of the vehicle and update the navigation data in real time.

Further, a vehicle to which an ESC is mounted can detect a speed bump using vehicle data measured by the ESC even if a separate speed bump detection apparatus is not installed, and does not additionally require installation of and costs for an apparatus for detecting a speed bump.

In addition, an impact to the vehicle body and damage to a suspension can be prevented such that ride feedings can be improved, by allowing the vehicle to softly pass over a speed bump through control of the suspension.

Finally, because it is not necessary to separately update navigation data, time and costs for updating the navigation data are not required.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram of an exemplary speed bump detection apparatus according to the present invention.

FIG. 2 is a flowchart showing an exemplary method of detecting a speed bump by a controller according to the exemplary speed bump detection apparatus of the present invention.

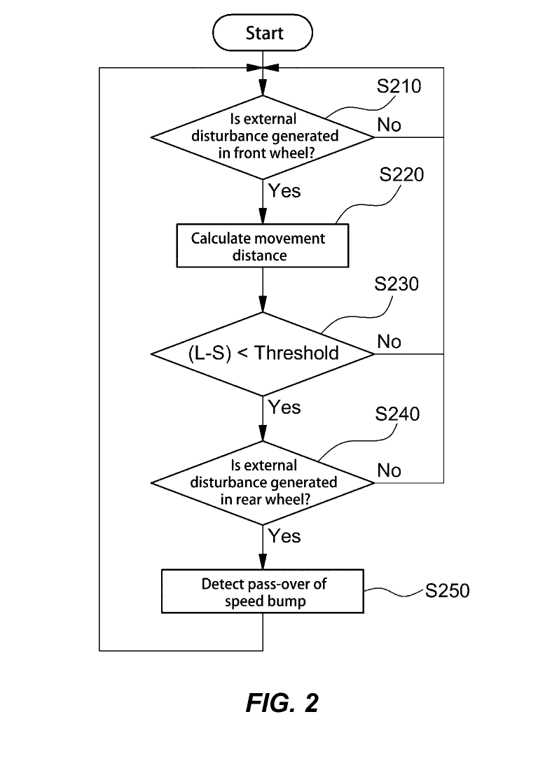

FIG. 3 is a flowchart of an exemplary navigation system according to the present invention.

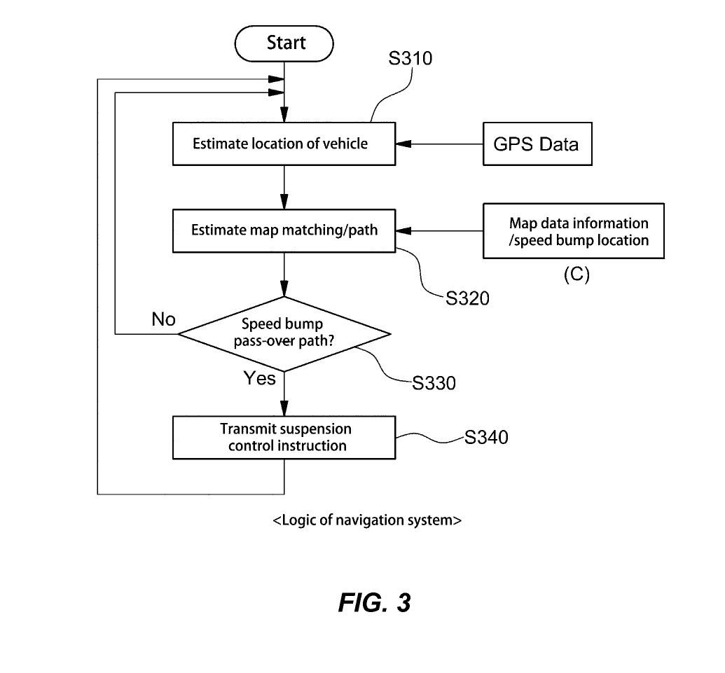

FIG. 4 is a flowchart of an exemplary navigation data updating method according to the present invention.

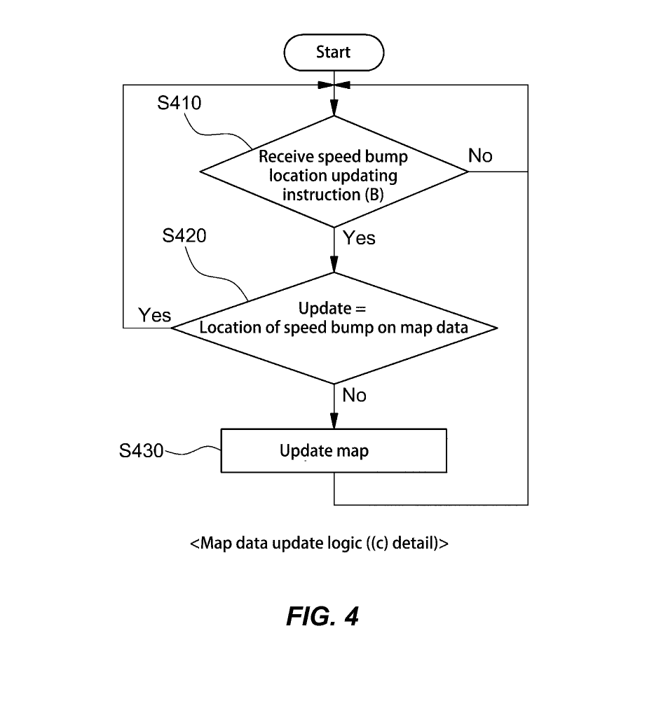

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention is adapted to detect generation of external disturbances and determine whether a speed bump is present through a process of recognizing a movement distance of a vehicle during generation of external disturbances in a wheel base and front and rear wheels of the vehicle.

In the present invention, external disturbances refer to factors that change vehicle data as compared with driving of a vehicle on a flat road.

In various embodiments, a controller of a vehicle may detect external disturbances if a change in speed of a wheel or a change of a height of the vehicle exceeds a reference value when the vehicle passes over a speed bump.

Hereinafter, an apparatus for detecting a speed bump through external disturbances of front and rear wheels, and a navigation updating apparatus and a navigation updating method through the same according to embodiments of the present invention will be described.

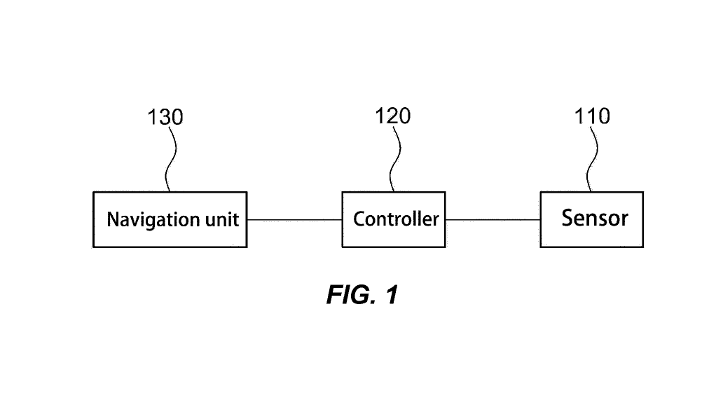

FIG. 1 is a diagram of a speed bump detection apparatus according to various embodiments of the present invention.

A speed bump sensor 110 for detecting external disturbances includes a wheel speed sensor, a vehicle height sensor, and a vehicle speed sensor. In addition, at least one sensor is provided to detect information on a speed of front wheels and information on a speed of rear wheels.

The speed bump sensor 110 measures vehicle data during driving of a vehicle, and may measure disturbance data generated at a time point when the vehicle passes over a speed bump. At least one sensor is required in each of the front wheels and the rear wheels.

For example, the sensor 110 using a wheel speed sensor may be mounted to a vehicle to which an Antilock Brake System (ABS) is mounted to measure a speed of a wheel. The wheel speed sensor serves to detect a rotating speed of a wheel using a tone wheel and a change in a magnetic force line of the sensor and input the detected rotating speed to the controller. The wheel speed sensor is installed in each of the four wheels. Thus, when the front wheels and rear wheels pass over a speed bump, data on rotating speeds of the wheels may be input to the controller through the wheel speed sensors.

The controller 120 may detect external disturbances generated when the vehicle passes over a speed bump through vehicle data collected by the sensors 110, calculate a movement distance of the vehicle after external disturbances are generated in the front wheels, and determine presence of a speed bump with the condition in which external disturbances are generated in the rear wheels. Preferably, the controller may include an Electronic Stability Control (ESC) device.

The controller 120 may detect external disturbances of the front wheels and external disturbances of the rear wheels, and may calculate a movement distance between time points when the detected external disturbances are generated.

Basically, the movement distance of the vehicle may be calculated through vehicle speed data collected by the controller. In an embodiment, the ESC may calculate a movement distance of the vehicle basically through usual calculations of the vehicle speed.

Presence of a speed bump may be determined through a set logic according to a distance value between the calculated movement distance and the wheel base of the vehicle.

In addition, information on a location of a speed bump may be collected and stored, and may be measured by at least one of a front wheel camera of the vehicle, a GPS, a radar, an antenna, a highway pass device, an RF terminal, and a front camera and a guide line detection sensor of the vehicle.

As an example of detecting external disturbances, in the present invention in which the sensors are wheel speed sensors, the controller 120 determines an external disturbance when a change rate of rotating speeds of wheels input from the wheel speed sensors to the ESC is a preset value or higher. When the vehicle has a vehicle height sensor, an external disturbance may be determined when a change rate of vehicle heights input to the ESC is a set value or higher.

The controller 120 includes an ESC, when the controller 120 detects an external disturbance of a front wheel (S210) while the vehicle passes over a speed bump, the controller 120 detects the speed bump (S250) if a movement distance (S220) of the vehicle after generation (S240) of external disturbances in the wheel base and the front wheels of the vehicle is a threshold value or lower (S230).

The movement distance of the vehicle may be calculated through integration of speed data of the vehicle basically usually calculated through the ESC:

S=∫ₜ₀^{t}v(t)dt

Accordingly, when a wheel base L of the vehicle is determined through various embodiments, a speed bump is detected in the condition in which external disturbances are generated in the rear wheels.

|L−S|≦k. Here, k is a preset threshold value.

An apparatus for updating navigation data after a speed bump is detected may include a controller 120, a navigation system 130, and a suspension.

The controller 120 stores location information after a speed bump is detected and transmits an update instruction of the navigation system accordingly, and the location information may be measured by at least one of a front wheel camera of the vehicle, a GPS, a radar, an antenna, a highway pass device, an RF terminal, and a front camera and a guide line detection sensor of the vehicle and may be stored in the controller.

After the step S310 of estimating a location of the vehicle, it is determined whether detected location information of a speed bump included in an update instruction 5410 received from the controller coincides with map information included in the navigation system (S420), and if not, the navigation data is updated (S430).

When a path of the vehicle is estimated (S320), a starting point of the vehicle may be set through map matching, and the suspension may be controlled in the case of a path passing through the speed bump.

The suspension may include an electronic control suspension. The electronic control suspension refers to a suspension system in which the front wheel and rear wheel suspensions are electronically controlled to increase ride feelings and steering stability.

The suspension system corresponds to a method of updating navigation data in advance, and driving the vehicle by controlling a damping force of the suspension through the controller (S340) when the vehicle passes over the speed bump detected during driving of the vehicle (S330) through the updated navigation data.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A speed bump detection apparatus comprising:
a sensor for measuring driving data of a vehicle during forward driving of the vehicle; and
a controller for monitoring generation of external disturbances of front wheels and rear wheels and determining presence of a speed bump,
wherein the controller determines that the speed bump is present when |L−S|≦K when an external disturbance is generated in a rear wheel, wherein L is a wheel base of the vehicle, S is a movement distance of the vehicle after an external disturbance is generated in a front wheel, and K is a preset threshold value.

2. The speed bump detection apparatus of claim 1, wherein the controller continuously monitors |L−S|, and detects the speed bump when a condition of |L−S|≦K is satisfied when an external disturbance is generated in the rear wheel.

3. The speed bump detection apparatus of claim 1, wherein the driving data comprises speeds of wheels, a speed of the vehicle, and a height of the vehicle.

4. The speed bump detection apparatus of claim 1, wherein the sensor comprises a wheel speed sensor, a vehicle height sensor, and a vehicle speed sensor.

5. The speed bump detection apparatus of claim 4, wherein the sensor comprises at least one sensor in each of the front wheels and the rear wheels of the vehicle.

6. The speed bump detection apparatus of claim 4, wherein the sensor comprises a wheel speed sensor, and the controller determines an external disturbance when a change rate in a rotating speed of a wheel is a preset value or higher.

7. The speed bump detection apparatus of claim 4, wherein the sensor comprises a vehicle height sensor, and the controller determines an external disturbance when a change rate in a height of the vehicle is a preset value or higher.

8. The speed bump detection apparatus of claim 1, wherein the controller is an Electronic Stability Control (ESC) device.

9. The speed bump detection apparatus of claim 1, wherein location information of the speed bump is measured by at least one of a front wheel camera of the vehicle, a GPS, a radar, an antenna, a highway pass device, an RF terminal, and a front camera and a guide line detection sensor of the vehicle.

10. A navigation data updating apparatus comprising:
a sensor for measuring driving data of a vehicle during forward driving of the vehicle; and
a controller for monitoring generation of external disturbances of front wheels and rear wheels of the vehicle, determining presence of a speed bump, calculating a location of the speed bump, and transmitting an update instruction based on the location of the speed bump; and
a navigation unit for receiving the update instruction and updating navigation data in real time,
wherein the controller determines that a speed bump is present when |L−S|≦K when an external disturbance is generated in a rear wheel, wherein L is a wheel base of the vehicle, S is a movement distance of the vehicle after an external disturbance is generated in a front wheel, and K is a preset threshold value.

11. The navigation data updating apparatus of claim 10, wherein the navigation unit updates the navigation data when the speed bump location information detected by the controller and map information on the navigation system are different.

12. The navigation data updating apparatus of claim 10, wherein the location information of the speed bump is measured by at least one of a front wheel camera of the vehicle, a GPS, a radar, an antenna, a highway pass device, an RF terminal, and a front camera and a guide line detection sensor of the vehicle.

13. A navigation data updating method comprising:
measuring driving data of a vehicle during driving of the vehicle, through a sensor;
monitoring generation of external disturbances of front wheels and rear wheels of the vehicle, determining presence of a speed bump, calculating a location of the speed bump, and transmitting an update instruction based on the location of the speed bump; and
receiving the update instruction and updating navigation data in real time,
wherein the controller determines that the speed bump is present when |L−S|≦K when an external disturbance is generated in a rear wheel, wherein L is a wheel base of the vehicle, S is a movement distance of the vehicle after an external disturbance is generated in a front wheel, and K is a preset threshold value.

14. The navigation data updating method of claim 13, wherein the navigation data is updated, when map information on the speed bump on the navigation system and detected location information detected of the speed bump are different.
